(19) United States
(12) Patent Application Publication
(10) Pub. No.: US 2012/0210388 A1
(43) Pub. Date: Aug. 16, 2012

(54) SYSTEM AND METHOD FOR DETECTING OR PREVENTING DATA LEAKAGE USING BEHAVIOR PROFILING

(76) Inventor: Andrey KOLISHCHAK, Andover, MA (US)

(21) Appl. No.: 13/370,825

(22) Filed: Feb. 10, 2012

Related U.S. Application Data
(60) Provisional application No. 61/441,398, filed on Feb. 10, 2011.

(51) Int. Cl. G06F 21/00

(52) U.S. Cl. 726/1

(57) ABSTRACT

Various embodiments provide systems and methods for preventing or detecting data leakage. For example, systems and methods may prevent or detect data leakage by profiling the behavior of computer users, computer programs, or computer systems. Systems and methods may use a behavior model in monitoring or verifying computer activity executed by a particular computer user, group of computer users, computer program, group of computer programs, computer system, or group of computer systems, and detect or prevent the computer activity when such computer activity deviates from standard behavior. Depending on the embodiment, standard behavior may be established on past computer activity executed by the computer user, or past computer activity executed by a group of computer users.

### CROSS-REFERENCE TO RELATED APPLICATION

The present application claims priority from and benefit of U.S. Patent Provisional Application No. 61/441,398, filed Feb. 10, 2011, entitled “Behavior Profiling for Detection and Prevention of Sensitive Data Leakage,” which is incorporated by reference herein.

### BACKGROUND

1. Technical Field

The present invention(s) relate to data leakage and, more particularly, to detecting or preventing such leakage in computer systems, especially when the computer system is on a network.

2. Description of Related Art

Leakage of sensitive data (also referred to herein as “data leakage” or “leakage”) is a significant problem for information technology security. It is well known that data leakage can lead not only to loss of time and money, but also loss of safety and life (e.g., when the sensitive data relates to national security issues). Generally, data leakage is intentionally perpetrated by unauthorized software (i.e., malicious software), unauthorized computer users (e.g., computer intruders) or authorized computer users (e.g., malicious insiders). However, at times, the leakage may be the unintentional result of software error (e.g., authorized software not operating as expected) or human error (e.g., authorized users inadvertently distributing sensitive data). Regardless of the intentionality, there are several means for addressing data leakage, including encryption and access control.

With encryption, data residing on data storage devices, data residing on data storage media, and data transitioning over a network does so in an encrypted state, where the data is not useful (i.e., data is unintelligible to a computer system or user) until it is converted to an unencrypted state. Encryption generally prevents unauthorized access or inadvertent leakage of sensitive data by those intruders who have physical or network access to the sensitive data. Unfortunately, encryption solutions generally do not prevent or detect data leakage caused by software and computer users that have access to the data in its unencrypted state.

Access control is another solution to data leakage. Under access control, discretionary or mandatory access control policies prevent access to sensitive data by authorized software and computer users. However, the most protective access control policies also tend to be the most restrictive and complicated. Consequently, applying and practicing access control policies can involve a high cost in time and money, and can disrupt business processes. Further still, access control usually cannot prevent or detect leakage that is intentionally or unintentionally caused by authorized computer users.

### SUMMARY OF EMBODIMENTS

Various embodiments provide systems and methods for preventing or detecting data leakage. In particular, various embodiments may prevent data leakage or detect data leakage by profiling the behavior of computer users, computer programs, or computer systems. For example, systems and methods may use a behavior model (also referred to herein as a “computer activity behavior model”) in monitoring or verifying computer activity executed by a particular computer user, group of computer users, computer program, group of computer programs, computer system, or group of computer systems (e.g., automatically), and detect or prevent the computer activity when such computer activity deviates from standard behavior. Depending on the embodiment, standard behavior may be established from past computer activity executed by a particular computer user, group of computer users, computer system, or a group of computer systems.

According to some embodiments, a system may comprise: a processor configured to gather user context information from a computer system interacting with a data flow; a classification module configured to classify the data flow to a data flow classification; a policy module configured to: determine a chosen policy action for the data flow by performing a policy access check for the data flow using the user context information and the data flow classification, and generate audit information describing the computer activity; and a profiler module configured to apply a behavior model on the audit information to determine whether computer activity described in the audit information indicates a risk of data leakage from the computer system. The data flow may pass through a channel that carries the data flow into or out from the computer system, and the user context information may describe computer activity performed on the computer system and associated with a particular user, a particular computer program, or the computer program.

In some embodiments, when the profiler module determines that the computer activity behavior associated with the particular user poses a risk of data leakage from the computer system, a future policy action determination by the policy module may be adjusted to account for the risk. For some embodiments, the future policy action determinations may be adjusted by adjusting or replacing a policy used by the policy module in its determination of the chosen policy action or by adjusting settings of the policy module. Additionally, in certain embodiments, the adjustment or replacement of the policy, or adjustment to the settings of the policy module, may be executed by one of several components, including the profiler module, the policy module, or the policy enforcement module.

As noted above, the data flow on the computer system may pass through a channel that carries data into or out from the computer system. A channel may be a software or hardware data path of the computer system through which a data flow may pass into the computer system or out. For example, the channel may be a printer, a network storage device, a portable storage device, a peripheral accessible by the computer system, an electronic messaging application or a web page (e.g., blog posting). The data flow through the channel may be inbound to or outbound from the computer system.

In particular embodiments, the policy module may determine the chosen policy action by performing a policy access check for the data flow, using either the user context information (e.g., gathered from the computer system), the data flow classification (e.g., determined by the classification module), or both. Using the processor to gathering user context information from the computer system may involve an agent module, operated by the processor, that is configured to so. The audit information generated by the policy module may describe the chosen policy action determined by the policy module, or may described the computer activity. The user context information may also describe computer activity, performed on the computer system and associated with a particular user, a particular computer program, or the computer system. Depending on the embodiment, the policy module may determine the chosen policy action in accordance with a policy that defines a policy action according to user context information, data flow classification, or both.

In various embodiments, the profiler module may comprise the behavior model. The behavior model may be configured to evaluate the audit information, and to generate an alert if the audit information, as evaluated by the behavior model, indicates that the computer activity poses a risk of data leakage from the computer system, possibly by the particular user or the particular computer program. In some embodiments, the profiler module may further comprise a threat module configured to receive an alert from the behavior model and determine a threat level based on the alert. Depending on the embodiment, the threat level might be associated with a particular user, group of users, computer program, group of computer programs, computer system, or group of computer systems. The threat level may indicate how much risk of data leakage the computer activity poses.

In particular embodiments where the system comprises two or more behavior models, the two or more behavior models may evaluate the audit information, and individually generate an alert if the policy audit information, as evaluated by an individual behavior model, indicates that the computer activity poses a risk of data leakage with respect to that individual behavior model. Evaluation of the audit information, by the individual behavior models, may be substantially concurrent or substantially sequential with respect to one another. Subsequently, the system may aggregate the alerts generated by the individual behavior models and, based on the aggregation, calculate an overall risk of data leakage from the computer system may be determined. Depending on the embodiments, this aggregation and calculation may be facilitated by the threat module, the policy module, the policy enforcement module, or some combination thereof. Additionally, for some embodiments where the alerts of two or more behavior models are aggregated, the alerts from different behavior models may be assigned different weights, which determine the influence of each alert on the overall risk of data leakage (e.g., certain alerts of certain behavior models have more influence calculation of an overall risk of data leakage, or in determining the threat level).

To store audit information, the system may further comprise an audit trail database configured to do so. The system may further comprise a decoder module configured to decode a data block in the data flow before the data flow is classified by the classification module. Additionally, the system may further comprise an interception module configured to intercept a data block in the data flow as the data block passes through the channel, and may further comprise a detection module, configured to detect when a data block in the data flow is passing through the channel.

Furthermore, the system may further comprise a policy enforcement module configured to permit or deny data flow through the channel based on the chosen policy action, or to notify the particular user or an administrator of a policy issue based on the chosen policy action. For example, the policy enforcement module may block a data flow involving the copying or transmission of sensitive data (e.g., over e-mail) based on a chosen policy action.

According to some embodiments, a method may comprise gathering user context information from a computer system interacting with a data flow, wherein the data flow passes through a channel that carries the data flow into or out from the computer system, and wherein the user context information describes computer activity performed on the computer system and associated with a particular user, a particular computer program, or the computer system; classifying the data flow to a data flow classification; determining a chosen policy action for the data flow by performing a policy access check for the data flow using the user context information and the data flow classification; generating audit information describing the computer activity; and applying a behavior model on the audit information to determine whether computer activity described in the audit information indicates a risk of data leakage from the computer system. The method may further comprise adjusting a future policy action determination when the computer activity associated with the particular user is determined to poses a risk of data leakage from the computer system.

For various embodiments, the method may further comprise determining a threat level based on an alert generated by the behavior model, where the threat level may be associated with the particular user, the particular computer program, or the computer system. Additionally, the chosen policy action may be determined in accordance with a policy that defines a policy action according to user context information and data flow classification.

In some embodiments, the method may further comprise decoding a data block in the data flow before the data flow is classified. Depending on the embodiment, the method may further comprise detecting a data block in the data flow as the data block passes through the channel, or intercepting the data block in the data flow as the data block passes through the channel (e.g., to permit or deny passage of the data block through the channel based on the chosen policy action). Additionally, the method may comprise generating a notification to the particular user or an administrator based on the chosen policy action.

According to various embodiments, a computer system, or a computer program product, comprises a computer readable medium having computer program code (i.e., executable instruction instructions) executable by a processor to perform various steps and operations described herein.

For embodiments implemented in a client-server environment (i.e., involving a client and server), it will be understood that various components or operations described herein may be implemented at one or more client-side computer systems and at one or more server-side computer systems.

### BRIEF DESCRIPTION OF THE DRAWINGS

Various embodiments are described in detail with reference to the following figures. The drawings are provided for purposes of illustration only and merely depict some example embodiments. These drawings are provided to facilitate the reader's understanding of the various embodiments and shall not be considered limiting of the breadth, scope, or applicability of embodiments.

FIG. 1 is a block diagram illustrating an exemplary system for detecting or preventing potential data leakage in accordance with some embodiments.

FIG. 2 is a block diagram illustrating an exemplary system for detecting or preventing potential data leakage in accordance with some embodiments.

FIG. 3 is a flow chart illustrating an exemplary method for detecting or preventing potential data leakage in accordance with some embodiments.

FIG. 4 is a flow chart illustrating an exemplary method for detecting or preventing potential data leakage in accordance with some embodiments.

FIG. 5 is a block diagram illustrating integration of an exemplary system for detecting or preventing potential data leakage with a computer operation system in accordance with some embodiments.

FIG. 6 is a screenshot of an example operational status in accordance with some embodiments.

FIG. 7 is a screenshot of an example user profile in accordance with some embodiments.

FIG. 8 is block diagram illustrating an exemplary digital device for implementing various embodiments.

### DETAILED DESCRIPTION OF THE EMBODIMENTS

To provide an overall understanding, certain illustrative embodiments will now be described; however, it will be understood by one of ordinary skill in the art that the systems and methods described herein may be adapted and modified to provide systems and methods for other suitable applications and that other additions and modifications may be made without departing from the scope of the systems and methods described herein.

Unless otherwise specified, the illustrated embodiments may be understood as providing exemplary features of varying detail of certain embodiments, and therefore, unless otherwise specified, features, components, modules, and/or aspects of the illustrations may be otherwise combined, separated, interchanged, and/or rearranged without departing from the disclosed systems or methods.

Various embodiments described herein relate to systems and methods that prevent or detect data leakage, where the leakage or detection is facilitated by profiling the behavior of one or more computers, one or more users, or one or more computer programs performing computer activity on one or more computer systems. The systems and methods may use a behavior model in monitoring or verifying computer activity executed by a computer user, and detecting or preventing the computer activity when such computer activity deviates from standard behavior. Depending on the embodiment, standard behavior may be established on past computer activity executed by a computer user, a group of computer users, a computer program, a group of computer programs, a computer system, or a group of computer systems. Additionally, by monitoring inbound or outbound data flow from the computer systems, various embodiments can detect or prevent data leakage via various data flow channels, including, for example, devices, printers, web, e-mail, and network connections to a network data share.

In some embodiments, the systems and methods may detect (potential or actual) data leakage, or may detect and prevent data leakage from occurring. Some embodiments may do this through transparent control of data flows that pass to and from computer systems, and may not require implementing blocking policy that would otherwise change user behavior. Furthermore, some embodiments do not require a specific configuration, and can produce results with automatic analysis of audit trail information.

Though some embodiments discussed herein are described terms of monitoring computer activity performed by a computer user or a group of computer users and detecting or preventing such computer activity when it poses a risk of data leakage, it will be understood that various embodiments may also monitor computer activity performed by a computer program, a group of computer programs, a computer system, or a group of computer systems.

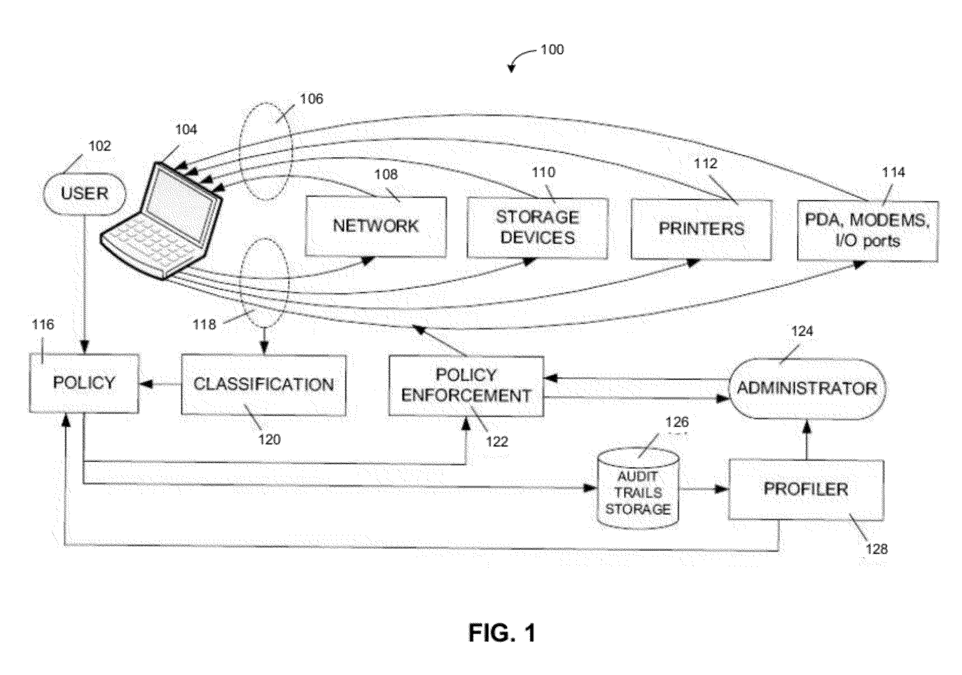

FIG. 1 is a block diagram illustrating an exemplary system 100 for detecting or preventing potential data leakage in accordance with some embodiments. The system 100 may comprise a computer system 104, a network 108, storage devices 110, printing device 112, and portable devices, modems, and input/output (I/O) ports 114. The system 100 may involve one or more human (computer) operators including, for example, a user 102, which may be operating a client-side computing device (e.g., desktop, laptop, server, tablet, smartphone), and an administrator 124 of the system 100, which may be operating a server-side or administrator-side computing device (not shown). The system 100 further comprises a policy module 116, a classification module 120, a policy enforcement module 122, a profiler module 126, and audit trails storage 126 (e.g., database).

According to some embodiments, the system 100 may monitor inbound data flows 106 to the computer system 104, or outbound data flows 118 from the computer system 104, as the user 105 performs operations (i.e., computer activity) on the computer system 104. For example, in FIG. 1 the classification module 120 may monitor only the outbound data flows 118 from the computer system 104. For some embodiments, the source of the inbound data flows 106, or the destination of the outbound data flows 118, may include the network 108, the storage devices 110, the printing device 112, and the portable devices, modems, and input/output (I/O) ports 114. Throughout this description, a software or hardware data path of a computer system through which a data flow may pass into or out of the computer system may be referred to herein as a “channel of data,” “data flow channel,” or just a “channel.” In FIG. 1, the network 108, the storage devices 110, the printing device 112, and the portable devices, modems, and input/output (I/O) ports 114 are just some exemplary channels that may be used with various embodiments.

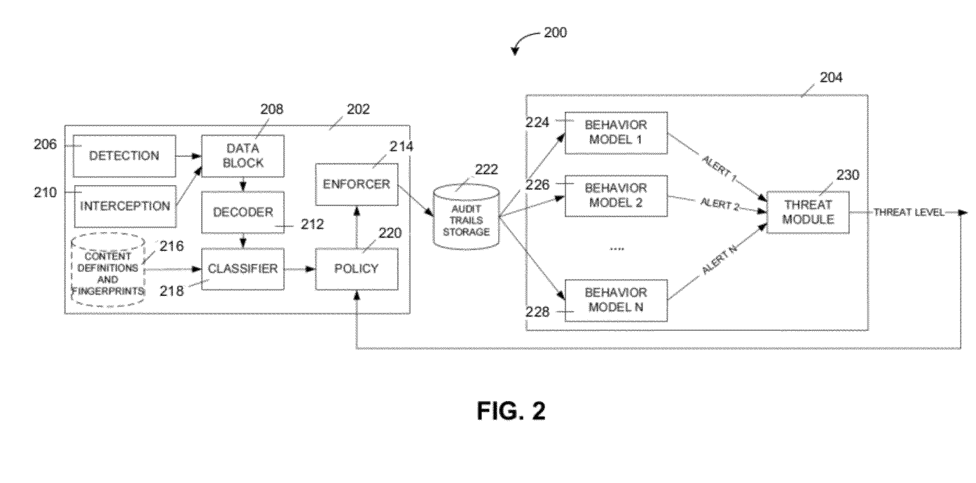

The classification module 120 may classify one or more data blocks in the inbound data flows 106 or the outbound data flows 118. For instance, the classification module 120 may classify data blocks as e-mail data, word processing file data, spreadsheet file data, or data determined to be sensitive based on a class definition (e.g., administrator-defined classification definition) or designation. For example, a class definition may define any data containing annual sales information as being sensitive data. In another example, all data from a certain network share may be automatically designated sensitive. For some embodiments, the classification definition may be defined according to a content recognition, such as hash fingerprints. More with respect to fingerprinting is discussed with respect to FIG. 2.

Classification information produced by the classification module 120 may be supplied to the policy module 116, which determines a policy action in response to the classified data blocks. In determining the policy action, the policy module 116 may utilize user context information, which is associated with the user 102 and describes the context in which the user 102 is operating the computer system 104. For example, the user context information may include user identity information (e.g., username of the user 102), application-related information (e.g., identify which applications are currently operating or installed on the computer system 104), or operations being performed on the computer system 104 (e.g., the user 105 is posting a blog a comment or article through a web browser, or the user 105 is sending an e-mail through an e-mail application or a web site). The policy module 116 may determine a policy action when, based on the classification information and/or the user context information, the policy module 116 detects a policy issue. For instance, the policy module 116 may determine a policy action when the user 105 copies a large amount of sensitive data (e.g., data classified as sensitive by the classification module) to a portable storage device 114, or prints a large amount of sensitive data to a printer device 112. Depending on the embodiment, the policy module 116 may determine one or more policy actions for a given data block.

Upon determination of a policy action by the policy module 116, the policy enforcement module 122 may perform the determined policy action. For example, in accordance with the determined policy action, the policy enforcement module 122 may permit or block one or more data blocks in the outbound data flow 118, in the inbound data flow 106, or both. Additionally, in accordance with the determined policy action, the policy enforcement module 122 may notify the user 102, the administrator 124, or both, when a policy issue is determined by the policy module 116.

As policy actions are determined (e.g., by the policy module 116) or enforced (e.g., by the policy enforcement module 122), information regarding the determined policy actions may be stored as audit information (also referred to herein as “audit trail information”), thereby maintaining a history of policy actions determined by the policy module 116 and a history of computer activity observed by the system 100. For example, where the determined policy action comprises permitting data blocks, denying data blocks, or notifying the administrator 124 of a policy issue, the audit information may comprise details regarding the permission, denial, or notification. In the audit information, details regarding past user computer activity and past determined policy actions may be maintained according to the particular user or computer program with which the determined policy actions are associated, or by the computer system with which the determined policy actions are associated. In various embodiments, the audit information may comprise information regarding an inbound or outbound data flow, regardless of whether a policy action is determined by the policy module 116.

Exemplary data fields stored in the audit information may include: data and time of a data operation (e.g., performed on the computer system 104); context user information (e.g., details on user, who performed the operation: name, domain, and user SID); details on data flow endpoints (e.g., workstation or laptop: machine name, machine domain, and machine SID); details on application that performed the data operation (e.g., full name of executable file, version information, such as product name, version, company name, internal name, executable file hash, list of DLLs loaded into application process address space, hashes of executable files, and signing certificate information); size of data transferred in a data flow; details on data source (e.g., file name, and content class); and details on a data source or destination, depending on the channel through which data is transferred.

Details on a data source or destination may include, for example: a file name, a device name, a hardware ID, a device instance ID, and a connection bus type for a device source or destination; a printer name, a printer connection type, and a printing job name for a printer source or destination; a file name, a server name, a server address, and a network share name, for a network share source or destination; a host name, a universal resource locator (URL), an Internet Protocol (IP) address, and a Transport Connection Protocol (TCP) port for a web source or destination; a destination address, a mail server IP address, and a mail server TCP port for an e-mail source or destination; or an IP address, and TCP port for an unrecognized IP protocol source or destination. In various embodiments, the audit information may be stored on, and subsequently retrieved from, the audit trails storage device 126.

The profiler module 128 may actively (e.g., real-time or near real-time) or retroactively retrieve audit information (e.g., from the audit trail storage 126) and verify policy actions or computer activity in the audit information using one or more behavior models. As described further within respect to FIG. 2, behavior models utilized by profiler module 128 may include: an operational risk model, a total size of transmitted data model, a number of transmission operations model, an average transmitted file size model, an applications-based model, a destinations-based model, or a devices-based model.

By actively or retroactively reviewing audit information for a particular user or group of users using one or more behavior models, the profiler module 128 may detect computer activity posing a risk of data leakage for a given time period (also referred to herein as an “audit period”). Then, upon detecting suspicious computer activity, the profiler module 128 may notify the user 105 (e.g., user warning via e-mail) or the administrator 124 (e.g., administrative alert via e-mail) of the suspicious computer activity, or adjust behavior of the policy module 116 (e.g., the future determination of policy actions) to address the questionable computer activity (e.g., implement more restrictive policy actions to be enforced by the policy enforcement module 122).

The profiler module 128 may recognize when recent computer activity poses a risk of data leakage by detecting a deviation between recent computer activity behavior (e.g., by a particular user, group of users, computer program, group of computer programs, computer system, or group of computer systems) stored in the audit information, and standard computer activity behavior (also referred to herein as “standard behavior”), which may be based on past computer activity stored in the audit information and associated with a particular user, group of users, computer system, or group of computer systems.

For some embodiments, the recent computer activity behavior may comprise computer activity in the audit information that falls within a specific audit period of time (e.g., the past 24 hours, or the past week) and is associated with the particular user, group of users, computer program, group of computer programs, computer system, or group of computer systems being reviewed for data leakage. In effect, the audit period may temporally scope the computer activity the profiler module 128 is considering for the potential of data leakage. The audit period may be statically set (e.g., by an administrator) or dynamically set (e.g., according to the overall current threat of data leakage).

For various embodiments, the standard behavior may be comprise past computer activity, for a relevant period of time, associated with a particular (a) user (e.g., based on the past computer activity of the user A currently being reviewed for data leakage), (b) of a particular group of users (e.g., based on the past computer activity of user group B, a group to which user A belongs), (c) of a particular computer system (e.g., based on the past computer activity of the computer system Y currently being reviewed for data leakage), or a group of computer systems (e.g., based on the past computer activity of computer group Z, a group to which computer system Y belongs), (d) of a particular computer program (e.g., based on the past computer activity of the computer program X currently being reviewed for data leakage). The standard behavior may be automatically established (e.g., self-learned) by the system 100, as the system 100 monitors the computer activity behavior of a particular user, group of users, computer program, group of computer programs, computer system, or group of computer systems, over time and stores the monitored computer activity as audit information. Subsequently, the system 100 can establish a standard pattern of computer activity behavior from the computer activity behavior stored as audit information. For example, the standard behavior may comprise computer activity in the audit information that falls within the relevant period and associated with a particular user, group of users, computer program, group of computer programs, computer system, or group of computer systems being reviewed for data leakage. Where the relevant period is set to a static time period (e.g., January of 2011 to February of 2011), the standard behavior may remain constant over time. Where the relevant period is relative to the current date (e.g., month-to-date, or including all past computer activity excluding the audit period), the standard behavior is dynamically changing over time. The relevant period may also be dynamic, and adjust in accordance with the current threat level detected by system 100.

Furthermore, for some embodiments, the standard behavior may be administrator-defined, or learned by the system 100 as a user or administrator's disposition policy issues raised by the policy module 116, or of computer activity designated by the profiler module 128 as posing a risk of data leakage. For instance, a user or administrator may respond to a data leakage notification issued by the profiler module 128 for identified computer activity, and the response by an administrator to ignore the notification may result in an adjustment to the standard behavior to avoid flagging the similar computer activity in the future.

When a sufficient deviation is detected, the recent computer activity behavior may be considered to pose a significant risk of data leakage. Accordingly, when a sufficient deviation (e.g., by a user, group of users, computer program, or group of computer programs) is detected from the standard behavior, the profiler module 128 may notify the administrator 124 of the deviation with information regarding the deviation, including such information as the user, group of users, computer program, or group of computer programs associated with the deviation, the one or more computer systems involved with the deviation, and time and date of the deviation.

As noted above, deviation detection may also cause the profiler module 128 to adjust future policy action determinations (e.g., made by the policy module 116) in order to address the detected risky computer activity. For some embodiments, an adjustment to future policy action determinations made by the policy module 116 may be facilitated through an adjustment of a policy utilized by the policy module 116 determining policy actions. Additionally, the adjustment to future policy action determinations may result in a corresponding change in enforcement by the policy enforcement module 122 (e.g., more denial of data flows by the policy enforcement module 122).

For some embodiments, the source of such monitored user behavior may be the past computer activity stored in the audit information. Depending on the embodiment, the relevant period of past computer activity on which a standard behavior is based may be relative to the current date (e.g., month-to-date), specific (e.g., January of 2011 to February of 2011), include all but the most recent computer activity (e.g., include all past user behavior monitored and stored in the audit information, excluding the last two weeks), or may be dynamic (e.g., based on the current threat level of system 100).

FIG. 2 is a block diagram illustrating an exemplary system 200 for detecting or preventing potential data leakage in accordance with some embodiments. The system 200 may comprise a client computer system 202, a profiler module 204, which may reside on the client computer system 202 or a separate computer system (e.g., a server computer system, not shown), and audit trails storage device 222, which may be a database that also resides on the client computer system 202 or a separate computer system (e.g., a database computer system, not shown).

The client computer system 202 may comprise a data flow detection module 206, a data flow interception module 210, a decoder module 212, a classifier module 218, a policy module 220, and a policy enforcer module 214. In order to facilitate functionality of the classifier module 218, the client compute system 202 may further comprise a content definition and fingerprints storage 216.

The data flow detection module 206 may be configured to read data blocks within a data flow (whether inbound or outbound) without modification to the data blocks or the data flow. With such a configuration, the data flow detection module 206 can transparently review data blocks within a data flow for data leakage detection purposes. In contrast, the data flow interception module 210 may be configured to read and intercept data blocks within a data flow (whether inbound or outbound), thereby allowing for modification of the data blocks or the data flow. Modification of the data blocks or data flow may facilitate the prevention of computer activity that poses a risk of data leakage. In some embodiments, the data flow detection 206 and/or the data flow interception module 210 may operate at an endpoint, such as a desktop, a laptop, a server and mobile computing device, or at network gateway. In various embodiments, the data flow interception module 210 may be further configured to gather context information regarding the client computer system 202, and possibly provide the context information (e.g., to the policy module 220) for determination of a policy action.

In case of an outbound data flow, either the data flow detection module 206, or the data flow detection module 206, may supply one or more data blocks 208, from outbound data flow, to a decoder module 212. The decoder module 212, in turn, may be configured to receive the data blocks 208 and decode the content of data blocks 208 from a format otherwise unintelligible (i.e., unreviewable) to the system 200, to a format that is intelligible (i.e., reviewable) to the system 200.

For instance, where one or more data blocks 208 from a data flow contain the contents of a Microsoft® Excel® spreadsheet, the data block module 212 may decode the data blocks 208 from a binary format to a content-reviewable format such that the system 200 (and its various components) can review the content of the spreadsheet cells (e.g., for data flow classification purposes). In another example, the decoder module 212 may be configured to decrypt encrypted content of the data blocks 208, which may otherwise be unintelligible to the system 200. By enabling review of content stored in the data blocks 208, the system 200 can subsequently classify, and determine the sensitivity nature of, of data flows according to their associated data blocks.

The classifier module 218 may be configured to receive the data blocks 208, review the data blocks 208, and based on the review, classify the data flow associated with the data blocks 208 to a data classification. In some instances, the classifier module 218 may need to review two or more data blocks of a data flow before a classification of the data flow can be performed. Depending on the embodiment, the classifier module 218 may classify the data flow according to the source of the data blocks 208 (e.g., the data blocks 208 is from a data flow carried through an e-mail channel), the file type associated with the data blocks 208 (e.g., Excel® spreadsheet), the content of the data blocks 208 (e.g., data block contains text marked confidential), the destination, or some combination thereof. As noted above, where the classifier module 218 classifies a data flow based on the content of one or more data blocks, the classifier module 218 may be capable of reviewing the content of the data blocks 208 only after the content has been decoded to a content-reviewable format by the decoder module 212.

When the classifier module 218 classifies the data blocks 208, the module 218 may generate classification information associated with the data blocks 208. The classification information may contain sufficient information for the system 200 to determine a policy action (e.g., by a policy module 220) in response to data flow classification.

In some embodiments, the client compute system 202 may further comprise the content definition and fingerprints storage 216, which facilitates classification operations by the classifier module 218, particularly with respect to data flow classification based on content of the data blocks 208. For example, the content definition of storage 216 may describe sources of sensitive data (e.g., network share locations, directory names, and the like). In accordance with a particular content definition from the storage 216, the classifier module 218 may automatically classify data flows as sensitive when they contain data blocks originating from a source described in the particular content definition.

Fingerprints from the storage 216 may comprise a unique or semi-unique identifier for data content designated to be sensitive. The identifier may be generated by applying a function, such a hash function or a rolling hash function, to the content to be identified. For example, a hash function may be applied to content of the data blocks 208 to generate a fingerprint for the content of the data blocks 208. Once a fingerprint is generated for the content of the data blocks 208, the system 200 can attempt to match the generated fingerprint with one stored in the storage 216. When a match is found in the storage 216, the match may indicate to the classifier module 218 (at least a strong likelihood) that the content of the data blocks 208 is sensitive in accordance with the fingerprints stored in the storage 216.

Based on classification information received from the classifier module 218, the policy module 220 may determine a policy action in response to the classification of the data flow. For example, when the classification information indicates that a data flow contains sensitive data, the policy module 220 may determine a policy action that the data flow should be blocked (e.g., in order to prevent data leakage), that the user should be warned against proceeding with the data flow containing sensitive data, that an administrator should be notified of the data flow containing sensitive data (e.g., in order to prevent data leakage), or that the occurrence of the data flow should be recorded (e.g., for real-time, near real-time, or retroactive auditing by the profiler module 204). The policy module 220 may further determine a policy action based on context information, such as the current logged user, current application processes, data/time, network connection status, and a profiler's threat level.

The policy enforcer module 214 may be configured to execute (i.e., enforce) the policy action determined by the policy module 220. Continuing with the example described above, in accordance with a determined policy action, the policy enforcer module 214 may block a data flow (e.g., in order to prevent data leakage), warn a user against proceeding with the data flow containing sensitive data, notify an administrator of the data flow containing sensitive data (e.g., in order to prevent data leakage), or record the occurrence of the questionable data flow (e.g., for real-time, near real-time, or retroactive auditing by the profiler module 204).

After the policy module 220 determines a policy action, or after the policy enforcer module 214 acts in accordance with the determined policy action, audit information may be generated, and possibly stored to, the audit trails storage 222. In general, the audit information may contain a history of past computer activity as performed by a particular user, as performed by a particular group of users, or as performed on a particular computer system. For example, the audit information may comprise information regarding the data flow passing through the data flow detection module 206 or the data flow interception module 210, the classification of the data flow according to the classifier module 218, the policy action determined by the policy 220, or the execution of the policy action by the policy enforcer module 214. Depending on the embodiment, the audit information may be generated by the policy module 220, upon determination of a policy action, or by the policy enforcer module 214 after enforcement of the policy action.

In accordance with some embodiments, the audit information (e.g., stored to the audit trails storage) may be analyzed (e.g., in real-time, in near real-time, or retroactively) by the profiler module 204 to determine whether past computer activity associated with a particular user, group of users, computer program, group of computer programs, computer system, or group of computer systems indicates a risk (or an actual occurrence) of data leakage by that particular user, group of users, computer program, group of computer programs, computer system, or group of computer systems. To perform this determination, the profiler module 204 may comprise one or more behavior models 224, 226, and 228, which the profiler module 204 utilizes in analyzing the audit information.

In particular, the profiler module 204 may supply each of the one or more behavior models 224, 226, and 228, with audit information (e.g., from the audit trails storage 222), which each of the behavior models 224, 226, and 228 uses to individually determine whether a risk of data leakage exists. Each of the behavior models 224, 226, and 228 may be configured to analyze different fields of data provided in the audit information, and may compare the current computer activity (e.g., associated with a particular user, group of users, computer program, group of computer programs, computer system, or group of computer systems) with past computer activity (e.g., associated with a particular user, group of users, computer program, group of computer programs, computer system, or group of computer systems) recorded in the audit information. From the comparison, the profiler module 204 determines if a sufficient deviation exists in the comparison to indicate a risk of data leakage (based on abnormal behavior).

When an individual behavior model determines that a risk of data leakage exists (e.g., a sufficient deviation exists between past and current computer activity), the individual behavior model may generate an alert to the profiler module 204. For some embodiments, each of the behavior models 224, 226, and 228 may comprise a function configured to receive as input audit information from the audit trails storage 222, and produce alert as a functional result. The function may be calculated periodically (e.g., every 5 minutes), or on update of information on the audit trails storage 222.

To determine the overall risk of a data leakage from the behavior models 224, 226, and 228, the profiler module 204 may further comprise a threat module 230, configured to receive one or more alerts from the behavior models 224, 226, and 228, and calculate a threat level based on the received alerts. The threat level, which may be a numerical value, may be associated with a particular user, group of users, computer program, group of computer programs, computer system, or group of computer systems and indicate how much risk of data leakage is posed by the computer activity associated with that particular user, group of users, computer program, group of computer programs, computer system, or group of computer systems. For instance, the threat level may be associated with all computer systems residing on an internal corporate network. For some embodiment, the higher the threat level, the more likely the chances of data leakage.

For some embodiments, the alert of each of the behavior models 224, 226, and 228 may have a different associated weight that corresponds with the influence of that alert on the calculation of the threat level. In some embodiments, the threat module 230 may be further configured to supply the threat level to the policy module 220, which may adjust future determinations of policy action in response to the threat level (i.e., to address the threat level). Depending on the threat level and its association, the policy module 220 may adjust future determinations of policy action according to a particular user, group of users, computer program, group of computer programs, computer system or group of computer systems. For example, if the threat level exceeds a particular threshold the policy module 220 may supply blocking policy actions to the policy enforcer module 214. Additionally, if the threat level exceeds a particular threshold, then an administrator may be notified with details regarding the threat level.

As described herein, various embodiments may utilize one or more behavior models in detecting computer activity that poses a risk of data leakage. As also noted herein, some embodiments may utilize two or more behavior models concurrently to determine the risk of data leakage posed by a user's or a group of user's computer activities. Some examples of the behavior models that may be utilized include, but are not limited to, (a) an operational risk model, (b) a total size of transmitted data model, (c) a number of transmission operations model, (d) an average transmitted file size model, (e) an applications-based model, (f) a destinations-based model, or (g) a devices-based model.

The description that follows discusses each of these behavior models in detail. Depending on the embodiment, the one or more of the parameters below may utilized as input parameters for the behavior model(s) being utilized:
Channel weights—CW;
User weights—UW;
List of classes/groups that compose sensitive data—CSS;
List of file types that compose sensitive data—FTS;
Automatic calculation time period—CT;
Monitoring time period—MT;
Operational risk limits—ORL;
Total size limits—TSL;
Number of operations limit—NOL; and;
Average size limit—ASL.

Additionally, depending on the embodiment, the parameters below may be utilized as monitored parameters by the behavior model(s) being utilized:
User—U, identified by SID;
Channel—C (e.g., network share, printer, portable device, e-mail, web page);
Classes/groups—CS;
File types—FT;
Number of transfer operations—ON;
Size of transferred data—OS;
Content Sensitivity—CST, defining sensitivity of content;
Content Form—CF, defining form or representation of content;
Destination—DEST, defining data transfer destination;
Application—ATRST, defining application trustworthiness;
User—UTRST, defining the user's trustworthiness;
Machine—MTRST, defining a computer system's (i.e., machine's) trustworthiness; and
Date/Time—DT, defining time period and duration of operation.

Each monitored parameter may be obtained from the audit information gathered during operation of some embodiments. Furthermore, each input parameter may be set to a manufactured default, automatically calculated by an embodiment, automatically adjusted by an embodiment, or set to a specific value by, for example, an administrator.

The channel weights (CW) may define an assumed probability of risk that, in the event of a data leak, the channel associated with the channel weight is the source of the data leak. For some embodiments, a sum of all weights will be equal to 1. A table of example channels and associated channel weights follows.

| Channel | Weight |
|---|---|
| Network-shared Resource (e.g., network drive) | 0.05 |
| Printer | 0.05 |
| Portable Storage Device | 0.2 |
| E-mail | 0.3 |
| Web page | 0.4 |

The user weight (UW) may define an assumed probability of risk that, in the event of a data leak, the specific user associated with the user weight is the source of the data leak. For some embodiments, the user weight for users may be set to 1 by default.

The list of classes and groups that compose sensitive data (CSS) may, as the name suggests, comprise a list of data classes or data groups that would constitute sensitive data. For example, all data from a directory known to contain data considered by a particular organization as being classified or secret may be designated as sensitive data. In various embodiments, the list of classes and groups that compose sensitive data may be defined by an administrator.

Similarly, the list of file types that compose (FTS) may, as the name suggests, comprise a list of file types that would constitute sensitive data. For example, the list of file types may designate Microsoft® Excel® files (e.g., XLS and XLSX file extensions) as file types that contain sensitive data. For various embodiments, the list of file types that compose sensitive data may be defined by an administrator.

In various embodiments, where input parameters are automatically calculated or adjusted, the automatic calculate time period (CT) may be define the time period used to evaluate such automatic calculations. For instance, the automatic calculation time period may be set for 14 days.

Where the number of transfer operations (ON) or the size of transferred data (OS) is determined by a behavior model, various embodiments may utilize the monitoring time period (MT) to determine the number of transfer operations or the size of transferred data. For instance, the monitoring time period may be set for 1 day.

In some embodiments, the operational risk limit (ORL) utilized by a behavior model may be set to a static value, such as 0.5. Alternatively, various embodiments may automatically calculate the operational risk limit using the following algorithm.

$$1. Calculate {ORLS}_{i} ∈ \{ {ORLS}_{{CT}_{1}} , {ORLS}_{{CT}_{2}} , … , {ORLS}_{\frac{CT}{MT}} \} ,$$

where ORLS_{CT}_{ᵢ} is calculated as described in the alert algorithm described below with respect to the operational risk model.
2. Remove zero value elements from ORLS_{CT}_{ᵢ}.
3. Remove from ORLSᵢ all values that are below

$$mean ( {ORLS}_{i} ) - \frac{stdev ( {ORLS}_{i} )}{2} ,$$

where mean is the arithmetic mean, and stdev is the standard deviation.
4. Calculate

$${ORL}_{i} = mean ( {ORLS}_{i} ) + \frac{stdev ( {ORLS}_{i} )}{2} ,$$

where mean is the arithmetic mean, and stdev is the standard deviation.

In various embodiments, the total size limit (TSL) utilized by a behavior model may be set to a static value, such as 100 Mb. Additionally, in some embodiments, the total size limit may be automatically calculated using the following algorithm.

$$1. Calculate {TSLS}_{i} ∈ \{ {TSLS}_{{CT}_{1}} , {TSLS}_{{CT}_{2}} , … , {TSLS}_{\frac{CT}{MT}} \} ,$$

where TSLS_{CT}_{ᵢ} is calculated as described in the alert algorithm described below with respect to the total size of transmitted data model.
2. Remove zero value elements from TSLS_{CT}_{ᵢ}.
3. Remove from TSLSᵢ all values that are below

$$mean ( {TSLS}_{i} ) - \frac{stdev ( {TSLS}_{i} )}{2} ,$$

where mean is the arithmetic mean, and stdev is the standard deviation.
4. Calculate

$${TSL}_{i} = mean ( {TSLS}_{i} ) + \frac{stdev ( {TSLS}_{i} )}{2} ,$$

where mean is the arithmetic mean, and stdev is the standard deviation.

Depending on the embodiment, a total size limit may be commonly utilized in conjunction with all users, commonly utilized in conjunction with all users associated with a particular user group, or individually utilized in conjunction with particular users.

In certain embodiments, the number of operations limit (NOL) utilized by a behavior model may be set to as static value, such 1000 operations a day, or, alternatively, set by an automatic calculation. For example, the number of operations limit may be automatically calculated using the following algorithm.

$$1. Calculate {NOLS}_{i} ∈ \{ {NOLS}_{{CT}_{1}} , {NOLS}_{{CT}_{2}} , … , {NOLS}_{\frac{CT}{MT}} \} ,$$

where NOLS_{CT}_{ᵢ} is calculated as described in the alert algorithm described below with respect to the total size of transmitted data model.
2. Remove zero value elements from NOLS_{CT}_{ᵢ}.
3. Remove from NOLSᵢ all values that are below

$$mean ( {NOLS}_{i} ) - \frac{stdev ( {NOLS}_{i} )}{2} ,$$

where mean is the arithmetic mean, and stdev is the standard deviation.
4. Calculate

$${NOL}_{i} = mean ( {NOLS}_{i} ) + \frac{stdev ( {NOLS}_{i} )}{2} ,$$

where mean is the arithmetic mean, and stdev is the standard deviation.

In various embodiments, the average size limit (ASL) utilized by a behavior model may be set to as static value, such 80 Mb, or, alternatively, set by an automatic calculation. For instance, the average size limit may be automatically calculated using the following algorithm.

$$1. Calculate {ASLS}_{i} ∈ \{ {ASLS}_{{CT}_{1}} , {ASLS}_{{CT}_{2}} , … , {ASLS}_{\frac{CT}{MT}} \} ,$$

where ASLS_{CT}_{ᵢ} is calculated as described in the alert algorithm described below with respect to the average transmitted file size model.
2. Remove zero value elements from ASLS_{CT}_{ᵢ}.
3. Remove from ASLSᵢ all values that are below

$$mean ( {ASLS}_{i} ) - \frac{stdev ( {ASLS}_{i} )}{2} ,$$

where mean is the arithmetic mean, and stdev is the standard deviation.
4. Calculate

$${ASL}_{i} = mean ( {ASLS}_{i} ) + \frac{stdev ( {ASLS}_{i} )}{2} ,$$

In some embodiments, the content sensitivity (CST), content form (CF), destination (DEST), application trustworthiness (ATRST), user trustworthiness (UTRST), machine trustworthiness (MTRST), and date/time (DT) parameters may be assigned an integer value that both corresponds to a particular meaning with respect to the parameter and indicate the amount of contribution the parameter play in determining the risk of data leakage (e.g., the higher the interger value, the more the risk). For instance, in the case of content sensitivity (CST), the value of 0 may used for data constituting ‘Public Content,’ while data constituting ‘Credit Card Numbers,’ which indicates a higher risk of data leakage, may be designated the value of 3.

In some other examples, content sensitivity (CST), content form (CF), destination (DEST), application trustworthiness (ATRST), user trustworthiness (UTRST), machine trustworthiness (MTRST), and date/time (DT) may be assigned an integer value in accordance with the following tables.

Content Sensitivity (CST)

| Value | Description |
|---|---|
| 1 | Unclassified data |
| 2 | Nonpublic Personal Information |
| 3 | Financial Information |
| 4 | Personal Health Information |
| 5 | Intellectual Property |

Content Form (CF)

| Value | Description |
|---|---|
| 1 | Archive |
| 2 | Encrypted |
| 2 | Unknown format |
| 4 | Size bigger than 100 Mb |

Destination (DEST)

| Value | Description |
|---|---|
| 1 | Internal (local ip address ranges) |
| 2 | Network shares |
| 3 | Social Networks |
| 4 | Printers |
| 5 | Disk Drive |
| 6 | Webmail |
| 7 | File sharing |
| 8 | FTP |

Application Trustworthiness (ATRST)

| Value | Description |
|---|---|
| 1 | Trusted (all signed applications and DLLs in |
| | execution stack) |
| 2 | Untrusted (all others) |

User Trustworthiness (UTRST)

| Value | Description |
|---|---|
| 1 | Domain user |
| 2 | Local user |
| 3 | Non-interactive user |

Machine Trustworthiness (MTRST)

| Value | Description |
|---|---|
| 1 | Domain member |
| 2 | Non-domain machine |

Date/Time (DT)

| Value | Description |
|---|---|
| 1 | Working time (Mon.-Fr.), excluding holidays |
| | and 7:00-19:00 time in accordance with local |
| | time zone |
| 2 | Non-working time (all others) |

With regard to the operational risk model, for some embodiments, the operational risk model may be configured to generate an alert when the percentage of data being transferred, that is classified as sensitive (e.g., by the classifier module 218), reaches a specific percentage (e.g., 60%), and that specific percentage deviates from the standard behavior associated with the user in question (or with a user group associated of that user in question). For example, with reference to the input parameters and monitored model parameters described herein, an alert function algorithm for the operational risk model may be defined as follows.
1. DS=U×l , where CS ε CSS and FT ε FTS,
   where DS is sensitive data.
2. DA=U×C,
   where DA is all data.
3. For every MT, calculate:

KOS_{MT}_{ᵢ}ε{OS₁,OS₂, . . . ,OS_{|DS|}},
where MTᵢ represents a monitored time period (e.g., particular day),
where

$${KOS}_{i} = {\sum }_{j = 1}^{MTN} {OS}_{j} \times {CW}_{j} \times {UW}_{j} ,$$

and
where MTN is the number of transfer operations within MT for which CS ε CSS and FT ε FTS.
4. For every MT, calculate:

OA_{MT}_{ᵢ}ε{OA₁,OA₂, . . . ,OA_{|DA|}},
where

$${KOA}_{i} = {\sum }_{j = 1}^{MTN} {OS}_{j} \times {CW}_{j} \times {UW}_{j} ,$$

and
where MTN is the number of transfer operations within MT.
5. |OR|=|DS|=|DA|.
6. Calculate:

ORε{OR₁,OR₂, . . . ,OR_{|DR|}},
where

$${OR}_{i} = \frac{{KOS}_{i}}{{KOA}_{i}} , i ∈ \{ 1 , 2 , … , \vert DR \vert \} .$$

7. If ORᵢ>ORLᵢ, then generate alert for MT.

With regard to an alternative operational risk model, the alternative operational risk model may be configured to calculate a risk and then generate an alert when that risk reaches or surpasses a defined threshold. For instance, with reference to the monitored model parameters described herein, a risk calculation algorithm for the alternative operational risk model may be defined as follows.
1. Calculate

$${Risk}_{i} = \frac{\begin{matrix}{CST}_{i} {W}_{C} + {CF}_{i } {W}_{CF} + {DST}_{i} {W}_{D} + {ATRST}_{i} {W}_{A} + \\ {UTRST}_{i} {W}_{U} + {MTRST}_{i } {W}_{M} + {DT}_{i} {W}_{DT}\end{matrix}}{\begin{matrix}\vert CST \vert {W}_{C} + \vert CF \vert {W}_{CF} + \vert DST \vert {W}_{D} + \vert ATRST \vert {W}_{A} + \\ \vert UTRST \vert {W}_{U} + \vert MTRST \vert {W}_{M} + \vert DT \vert {W}_{DT}\end{matrix}} ,$$

where CSTᵢ, CFᵢ, DSTᵢ, ATRSTᵢ, UTRSTᵢ, MTRSTᵢ, DTᵢ are entity values for operation i,
where |CST|, |CF|, |DST|, |ATRST|, |UTRST|, |MTRST|, |DT| are cardinality of entity sets,
where W_{C}, W_{CF}, W_{D}, W_{A}, W_{U}, W_{M}, W_{DT} are weight coefficients indicating contribution of each entity to the risk, and
where W_{C}, W_{CF}, W_{D}, W_{A}, W_{U}, W_{M}, W_{DT} may assigned the following values.

Weights

| Parameter | Weight |
|---|---|
| CST | 10 |
| CF | 10 |
| DEST | 10 |
| ATRST | 10 |
| UTRST | 7 |
| MTRST | 7 |
| DT | 5 |

2. Calculate a user's risk at a particular moment

Riskᵤₛₑᵣ=max(Riskᵢ),
where Riskᵢε{Risk₁, Risk₂, . . . Riskₙ} is a set of evaluated risks for a user starting from the beginning of day.

With regard to the total size of transmitted data model, for some embodiments, the total size of transmitted data model may be configured to generate an alert when the amount of data being transferred, that is classified as sensitive (e.g., by the classifier module 218), reaches a specific amount (e.g., 100 Mb), and that specific amount deviates from the standard behavior associated with the user in question (or with a user group associated of that user in question). For instance, with continued reference to the input parameters and monitored model parameters described herein, an alert function algorithm for the total size of transmitted data model may be defined as follows.
1. DS=U×C, where CS ε CSS and FT ε FTS.
2. For every MT, calculate:

KOS_{MT}_{ᵢ}ε{OS₁,OS₂, . . . ,OS_{|DS|}},
where

$${KOS}_{i} = {\sum }_{j = 1}^{MTN} {OS}_{j} \times {CW}_{j} \times {UW}_{j} ,$$

and
where MTN is the number of transfer operations within MT for which CS ε CSS and FT ε FTS.
3. If KOSᵢ>TSLᵢ, then generate alert for MT.

With regard to the number of transmission operations model, for some embodiments, the number of transmission operations model may be configured to analyze the number of data transfer iterations that have taken place (e.g., how many e-mails have been sent, documents have been printed, files saved to a Universal Serial Bus (USB) memory stick, or files uploaded to the web) and generate an alert if that number deviates from the standard behavior associated with the user in question (or with a user group associated of that user in question). With reference to the input parameters and monitored model parameters described herein, an exemplary alert function algorithm for the number of transmission operations model may be defined as follows.
1. DS=U×C, where CS ε CSS and FT ε FTS.
2. For every MT, calculate:

KON_{MT}_{ᵢ}ε{OS₁,OS₂, . . . ,OS_{|DS|}},
where MTᵢ represents a monitored time period (e.g., particular day),
where

$${KON}_{i} = {\sum }_{j = 1}^{MTN} {OS}_{j} \times {CW}_{j} \times {UW}_{j} ,$$

and
where MTN is the number of transfer operations within MT for which CS ε CSS and FT ε FTS.
3. If KONᵢ>NOLᵢ, then generate alert for MT.

With regard to the average transmitted file size model, for some embodiments, the average transmitted file size model may be configured calculate the average transmitted file size and generate an alert if that number deviates from the standard behavior associated with the user in question (or with a user group associated of that user in question). With continued reference to the input parameters and monitored model parameters described herein, an exemplary alert function algorithm for the number of transition operations model may be defined as follows.
1. DS=U×C, where CS ε CSS and FT ε FTS
2. For every MT, calculate:

KOA_{MT}_{ᵢ}ε{OS₁,OS₂, . . . ,OS_{|DS|}},
where MT, represents a monitored time period (e.g., particular day),
where

$${KOA}_{i} = {\sum }_{j = 1}^{MTN} \frac{{OS}_{j}}{{ON}_{j}} \times {CW}_{j} \times {UW}_{j} ,$$

and
where MTN is the number of transfer operations within MT for which CS ε CSS and FT ε FTS
3. If KOAᵢ>ASLᵢ, then generate alert for MT.

With regard to the applications-based model, for some embodiment, the applications-based model may be configured to generate an alert when the model encounters, in the audit information, computer activity involving an application that is generally not used, or that has never been used before, from the perspective of the standard behavior associated with the user in question (or with a user group associated of that user in question). A situation where computer activity in the audit information may cause the applications-based model to trigger an alert may include, for example, where the computer activity associated with a non-programming user involves application associated with software development, such as a debugger application, an assembler program, or a network packet sniffing application.

In certain embodiments, the applications-based model may use as an input parameter a list of trusted software applications (AS), and as a monitored model parameter, an application name (A). Depending on the embodiment, the list of trusted applications may comprise the file name utilized in the audit information (e.g., file name+InternalFileName), or comprise the actual executable file name of the application. In addition, as noted herein, the monitored model parameter may be retrieved from the audit information gathered during operation of some embodiments. In view of the foregoing parameters, the alert algorithm function for the applications-based model may be defined as follows.
1. If AS is not empty and AS∩A≠A, then generate an alert

With regard to the destinations-based model, for some embodiment, the destinations-based model may be configured to generate an alert when the model encounters, in the audit information, computer activity involving a data flow destination generally not encountered, or ever used, from the perspective of the standard behavior associated with the user in question (or with a user group associated of that user in question). For example, where audit information indicates that the computer activity associated with a user involved e-mailing sensitive data to an e-mail address not found in the standard behavior associated with the user (e.g., never previously encountered in the user's previous computer activities), the destinations-based model may trigger an alert.

In various embodiments, the destinations-based model may use as an input parameter a list of data flow destination names (DS), and as a monitored model parameter, a data flow destination name (D). The names used in the list of data flow destination names, and used for the destination name, may vary from channel to channel. For example, the list of data flow destination names may comprise a file name for device channels, an e-mail address for e-mail channels, and a URL for a web page. Likewise, the data flow destination name may comprise a file name for device channels, an e-mail address for e-mail channels, and a URL for a web page. As described herein, the monitored model parameter may be retrieved from the audit information gathered during operation of some embodiments. Based on the foregoing parameters above, the alert algorithm function for the destinations-based model may be defined as follows.
1. If DS is not empty and DS∩D≠D, then generate an alert

With regard to the devices-based model, for some embodiment, the devices-based model may be configured to generate an alert when the model encounters, in the audit information, computer activity involving a device hardware generally not encountered, or ever used, from the perspective of the standard behavior associated with the user in question (or with a user group associated of that user in question). A situation where computer activity in the audit information may cause the devices-based model to trigger an alert may include, for example, where the computer activity associated with a user involves copying data to a portable storage device not found in the standard behavior associated with the user (e.g., never previously encountered in the user's previous computer activities).

In some embodiments, the devices-based model may use as input parameters a list of trusted device hardware identifiers (DHS) and a list of trusted unique instances (DIS). Correspondingly, the devices-based model may use as monitored model parameters, a device hardware identifier (DH), which may represent a particular device model (there can be many devices of the same model), and a device unique instance (DI), which may represent a unique device serial number. The names used in the list of trusted device hardware identifiers, and used for the device hardware identifier, may correspond to the identifier utilized in the audit information, which may employ the device identifier/name provided by the computer system operating system (i.e., computer operation system) that is controlling operations of the device. Likewise, the names used in the list of trusted unique instances, and used for the device unique instance, may correspond to the instance designator utilized in the audit information. As previously noted herein, the monitored model parameters may be retrieved from the audit information gathered during operation of some embodiments. Based on the foregoing parameters above, the alert algorithm function for the devices-based model may be defined as follows.
1. If DHS is not empty and DHS∩DH≠DH, then generate an alert
2. If DIS is not empty and DIS∩DI≠DI, then generate an alert

In accordance with some embodiments, where alerts from two or more behavior models are aggregated together to determine the threat level (e.g., for a particular user, or a group of users), the alerts may be assigned a corresponding weight based on the behavior model generating the alert. For example, the threat module 230 may be configured to aggregate the alerts from the behavior models 224, 226, and 228 using the following formula.

$$ThreatLevel = {\sum }_{i = 0}^{N} {Alert}_{i} \times {Weight}_{i} \qquad Equation 1$$

For some embodiments that utilize (a) an operational risk model, (b) a total size of transmitted data model, (c) a number of transmission operations model, (d) an average transmitted file size model, (e) an applications-based model, (f) a destinations-based model, and (g) a devices-based model, the weights of the alert may be assigned in accordance with the following table.

| Model Generating Alert | Weight |
|---|---|
| Operational Risk Model | 1 |
| Total Size of Transmitted Data | 1 |
| Number of Transmission Operations | 1 |
| Average Transmitted File Size | 1 |
| Applications-based | 2 |
| Destinations-based | 2 |
| Devices-based | 2 |

Embodiments using the foregoing weight assignments may consider computer activity involving new or rarely used applications, data flow destinations, or devices more risky with respect to data leakage, than computer activity that triggers alerts from operational the operational risk model, the total size of transmitted data model, the number of transmission operations model, or the average transmitted file size model.

In addition to the behavior models described above, other behavior models may include behavior models based on a neural network, such as a self organizing map (SOM) network.

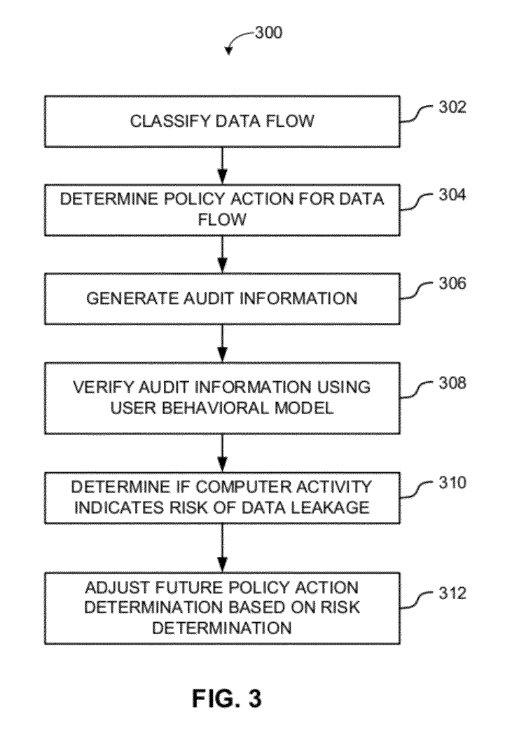

FIG. 3 is a flow chart illustrating an exemplary method 300 for detecting or preventing potential data leakage in accordance with some embodiments. The method 300 begins at step 302, where a data flow may be classified by the classifier module 218. During classification of the data flow, classification information may be generated by classifier module 218. As note herein, the classifier module 218 may classify the data flow according to a variety of parameters, including the source or destination of the data flow, the file type associated with the data flow, the content of the data flow, or some combination thereof.

In step 304, the policy module 220 may determine a policy action for the data flow. For some embodiments, the policy module 220 may utilize the classification information generated by the classifier module 218 to determine the policy action for the data flow. For instance, when the classification information indicates that a data flow contains sensitive data, the policy module 220 may determine a policy action indicating that the data flow should be blocked, that the user should be warned against proceeding with the data flow containing sensitive data, that an administrator should be notified of the data flow containing sensitive data, or that the occurrence of the data flow should be recorded. Subsequently, the policy enforcer module 214 may execute (i.e., enforce) the policy action determined by the policy module 220.

In step 306, the policy module 220 (or alternatively, the policy enforcer module 214) may generate audit information based on the determination of the policy action. As described herein, the audit information may contain a history of past computer activity as performed by a particular user, as performed by a particular group of users, or as performed on a particular computer system. In some embodiments, the audit information may comprise information regarding the data flow passing through the data flow detection module 206 or the data flow interception module 210, the classification of the data flow according to the classifier module 218, the policy action determined by the policy 220, or the execution of the policy action by the policy enforcer module 214.

In step 308, the profiler module 204 may verify the audit information using user behavioral models. For example, the profiler module 204 may supply each of the one or more behavior models 224, 226, and 228, with audit information, which each of the behavior models 224, 226, and 228 uses to individually determine whether a risk of data leakage exists. When an individual behavior model determines that a risk of data leakage exists (e.g., a sufficient deviation exists between past and current computer activity), the individual behavior model may generate an alert to the profiler module 204.

In step 310, the profiler module 204 may determine, based on the verification, if computer activity analyzed in the audit information indicates a risk of data leakage. For some embodiments, the profiler module 204 may utilize the threat module 230, to receive one or more alerts from the behavior models 224, 226, and 228, and calculate a threat level based on the received alerts. The resulting threat level may indicate how much risk of data leakage the computer activity associated with a particular user, group of users, computer system, or group of computer systems poses.

In step 312, the policy module 220 may adjust future determinations of policy actions based on the risk determination of step 310. In some embodiments, the profiler module 204 may supply the policy module 220 with the threat level calculated from the behavior models 224, 226, and 228, which the policy module 220 may use in adjusting future determinations of policy action (i.e., to address the threat level).

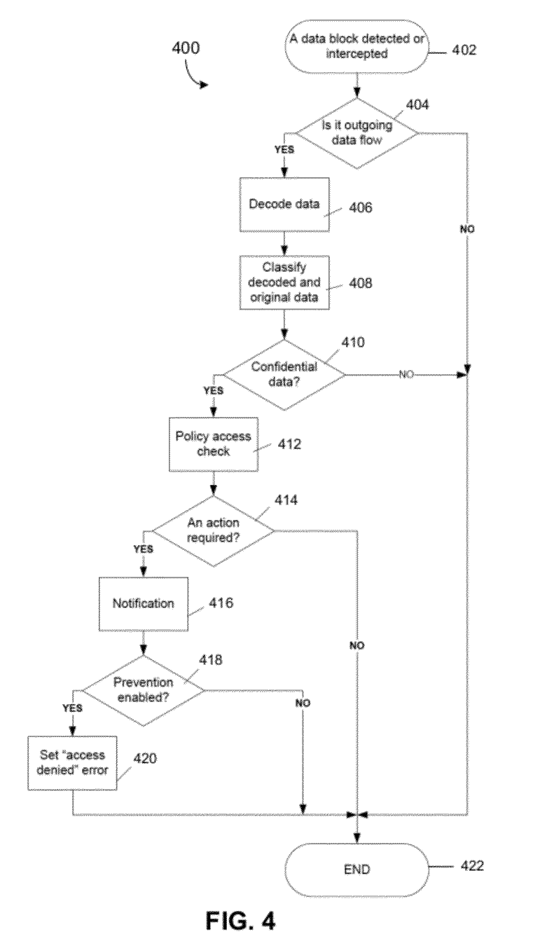

FIG. 4 is a flow chart illustrating an exemplary method 400 for detecting or preventing potential data leakage in accordance with some embodiments. The method 400 begins as step 402, with the detection of interception of one or more data blocks 208 in a data flow. For some embodiments, the data blocks 208 may be detected by the detection module 206, or the data blocks 208 may be intercepted by the data flow interception module 210. Additionally, at step 404, it may be determined whether the data flow is outgoing (i.e., outbound) or incoming. If the data flow is determined to be incoming, the method 400 may end at operation 422.

Assuming that the data flow is determined to be outgoing, in step 406, the decoder module 212 may decode the data block 208 in the data flow to decoded data. Then, in step 408, the classifier module 218 may classify the decoded data and/or the original data (i.e., the data blocks 208) depending on characteristics relate to or content of the decoded data. For instance, the classifier module 218 may classify the decoded data (and the original data) as sensitive data if confidential content is detected in the decoded data. Once the decoded data is classified as sensitive, the data flow associated with the decoded data may be classified sensitive.

At step 410, if the decoded data is considered to be sensitive (e.g., confidential), the policy module 220 may perform a policy access check on the data flow at step 412. During the policy access check, the policy module 220 may determine a policy action for the data flow, which may be subsequently enforced by the policy enforcer module 214. The policy access check may take into account current operation context, such as logged user, application process, data/time, network connection status, and a profiler's threat level.

At step 414, if the policy access check determines an action is required (e.g., notification of an administrator, or blocking a data flow), the policy enforcer module 214 may issue a notification at step 416. If, however, an action is determined not to be required, the method 400 may end at operation 422.

Based on the policy access check determined at step 414, in step 416 the policy enforcer module 214 may notify an administrator regarding potential sensitive data leakage. Depending on the embodiment, the method of notification (which may include graphical dialog messages, email messages, log entries) may be according to the policy action determined by the policy module 220.

At step 418, if prevention of data leakage is possible, the policy enforcer module 214 may instruct the data flow interceptor module 210 to block the data flow and issue an “access denied” error at step 420. If, however, prevention of data leakage is not possible, the method 400 may end at operation 422.

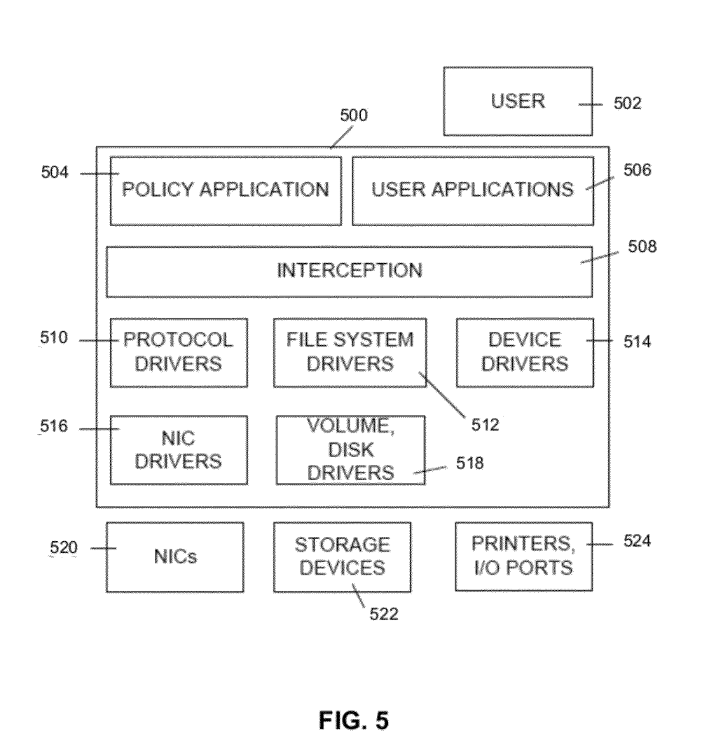

FIG. 5 is a block diagram illustrating integration of an exemplary system for detecting or preventing potential data leakage with a computer operation system 500 in accordance with some embodiments. In some embodiments, the data flow detection module 206, the data flow interception module 210, the decoder module 212, the classifier module 218, the policy module 220, and the policy enforcer module 214 may be integrated into computer operation system 500 as shown on FIG. 5.

The operation system 500 comprises a policy application 504, user application 506, a data flow interception module 508, protocol drivers 510, file system drivers 512, device drivers 514, network interface drivers 516, and volume disk drivers 518. Interfacing with the operation system 500

The operation system 500 may interact with a user 502 and devices, such as network interface cards 520, storage devices 522, printers and input/output (I/O) ports 524, and other devices that may be capable transferring confidential data from computer system. The data flow interception module 508 may operate in the operation system kernel, possibly above protocol drivers 510, file system drivers 512, and device drivers 514. By positioning the data flow interception module 508 accordingly, the data flow interception module 508 may intercept all incoming and outgoing data flows passing through the user applications 506, and may gather context operation information from the computer operation system 500.

In the case of the Microsoft® Windows® operation system, the data flow interception module 508 may be implemented as a kernel mode driver that attaches to the top of device drivers stacks. In particular, the kernel mode driver implementing the data flow interception module 508 may attach to the Transport Driver Interface (TDI) stack for network traffic interception purposes; to the file system stack for file interception purposes; and to other particular devices stacks for data flow interception to those corresponding devices. Interception at the middle or bottom of device stacks, such as network interface drivers 516 and volume disk drivers 518, may not provide operational context (i.e., context information) regarding the user 502 or the user applications 506.

For some embodiments, the policy application 504 may comprise the data flow detection module 206, the decoder module 212, the classifier module 218, the policy module 220, and the policy enforcer module 214. The data flow detection module 206 may detect incoming or outgoing data flow through, for example, the network interface cards 520 and the storage devices 522. With particular reference to the Microsoft® Windows® operation system, network data flow may be detected via standard a Windows® raw socket interface (e.g., with enabled SIO_RCVALL option), and storage device data flows may be monitored by a Windows® file directory management interface (e.g., FindFirstChangeNotification, FindNextChangeNotification functions of Windows Application Programming Interface).

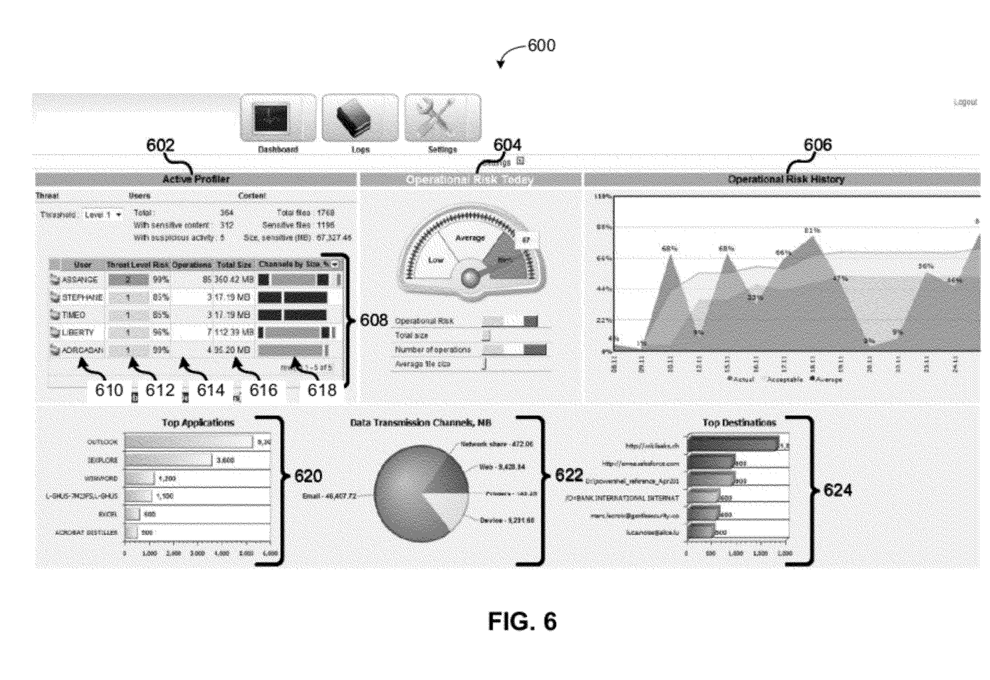

FIG. 6 is a screenshot of an example operational status 600 in accordance with some embodiments. Through use of the operational status 600, an administrator may determine the overall operational condition of some embodiments. For some embodiments, the operation status 600 may comprise an active profiler, a daily operational risk summary 604, an operational risk history, a list of top applications 620, percentages of data transmission by channels 622, a list of top channel endpoints 624.

The active profiler 602 may comprise a summary of users, a summary of user related associated computer activities (e.g., number of users, number of users with sensitive data, number of users involved in suspicious computer activity), total number of files, total number of sensitive files, and total amount of sensitive data. The active profiler 602 may further comprise a list of users 608 having an associated threat level. The list 608 includes a list of usernames 610, and, for each username, a threat level 612, a risky operations count 614, a total data amount 616, a channel breakdown 618.

The daily operational risk summary 604 may provide a summary of the overall operational risk currently observed of monitored client computer systems. The operational risk history 606 may provide a history of the overall operational risk observed of monitored client computer systems. The list of top applications 620 may list the top applications being operated by the users. The percentages of data transmission by channels 622 may provide breakdown of overall channel usage by amount of data. Additionally, the list of top channel endpoints 624 describes the list of top channel endpoints used by users.

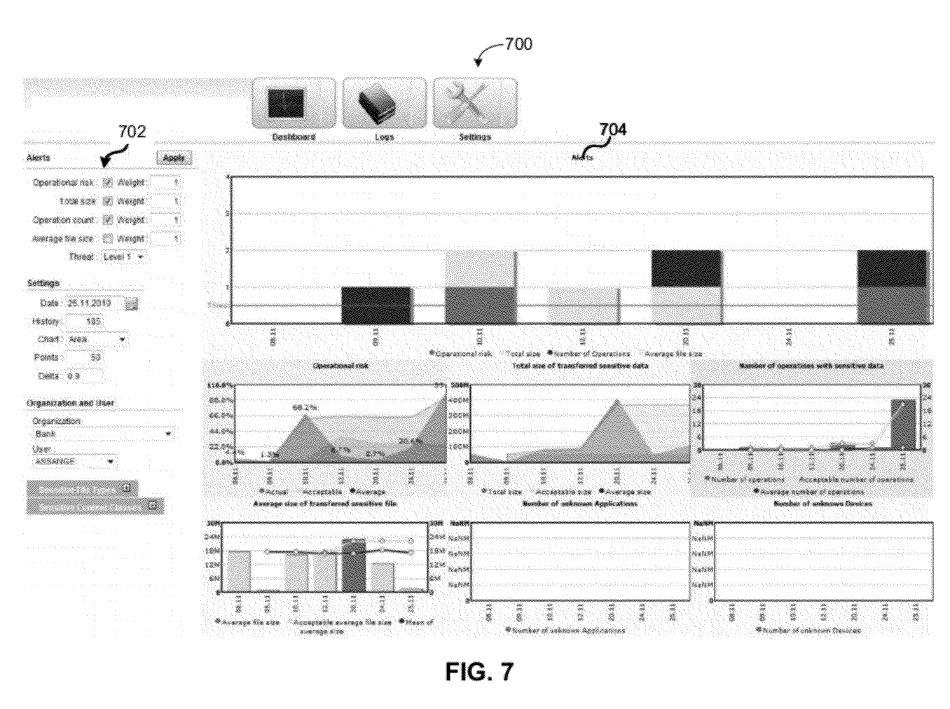

FIG. 7 is a screenshot of an example user profile 700 in accordance with some embodiments. Through the user profile 700, an administrator can generate and view a summary (or a report) of user's computer activities as observed by some embodiments. In particular embodiments, the user profile 700 may provide a summary of alerts (e.g., generated by behavioral models) generated by recent or past computer activity associated with a particular user. The user profile 700 may comprise an alert filters interface 702, which determines the scope of the summary (or report) provided, and a historical summary of alerts 704, in accordance with settings implemented using the alert filters interface 702.

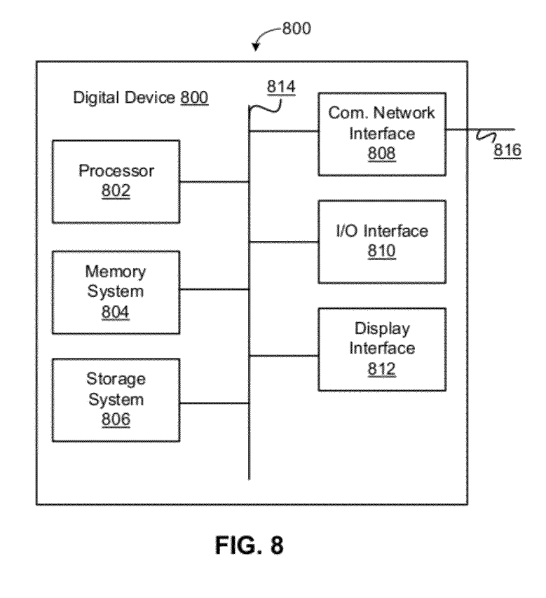

FIG. 8 is block diagram illustrating an exemplary digital device 800 for implementing various embodiments. The digital device 802 comprises a processor 804, memory system 806, storage system 808, an input device 810, a communication network interface 812, and an output device 814 communicatively coupled to a communication channel 816. The processor 804 is configured to execute executable instructions (e.g., programs). In some embodiments, the processor 804 comprises circuitry or any processor capable of processing the executable instructions.

The memory system 806 stores data. Some examples of memory system 806 include storage devices, such as RAM, ROM, RAM cache, virtual memory, etc. In various embodiments, working data is stored within the memory system 806. The data within the memory system 806 may be cleared or ultimately transferred to the storage system 808.

The storage system 808 includes any storage configured to retrieve and store data. Some examples of the storage system 808 include flash drives, hard drives, optical drives, and/or magnetic tape. Each of the memory system 806 and the storage system 808 comprises a computer-readable medium, which stores instructions or programs executable by processor 804.

The input device 810 is any device such an interface that receives inputs data (e.g., via mouse and keyboard). The output device 814 is an interface that outputs data (e.g., to a speaker or display). Those skilled in the art will appreciate that the storage system 808, input device 810, and output device 814 may be optional. For example, the routers/switchers 110 may comprise the processor 804 and memory system 806 as well as a device to receive and output data (e.g., the communication network interface 812 and/or the output device 814).

The communication network interface (corn. network interface) 812 may be coupled to a network via the link 818. The communication network interface 812 may support communication over an Ethernet connection, a serial connection, a parallel connection, and/or an ATA connection. The communication network interface 812 may also support wireless communication (e.g., 802.11a/b/g/n, WiMax, LTE, WiFi). It will be apparent to those skilled in the art that the communication network interface 812 can support many wired and wireless standards.

It will be appreciated by those skilled in the art that the hardware elements of the digital device 802 are not limited to those depicted in FIG. 8. A digital device 802 may comprise more or less hardware, software and/or firmware components than those depicted (e.g., drivers, operating systems (also referred to herein as “computer operation system”), touch screens, biometric analyzers, etc.). Further, hardware elements may share functionality and still be within various embodiments described herein. In one example, encoding and/or decoding may be performed by the processor 804 and/or a co-processor located on a GPU (i.e., Nvidia).

The above-described functions and components can comprise instructions that are stored on a storage medium such as a computer readable medium. Some examples of instructions include software, program code, and firmware. The instructions can be retrieved and executed by a processor in many ways.

The various embodiments described herein are provided for illustrative purposes only and merely depicts some example embodiments. It will be apparent to those skilled in the art that various modifications may be made and other embodiments can be used.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

The various embodiments described herein are provided for illustrative purposes only and merely depicts some example embodiments. It will be apparent to those skilled in the art that various modifications may be made and other embodiments can be used.

1. A system, comprising:
a processor configured to gather user context information from a computer system interacting with a data flow, wherein the data flow passes through a channel that carries the data flow into or out from the computer system, and wherein the user context information describes computer activity performed on the computer system and associated with a particular user, a particular computer program, or the computer system;
a classification module configured to classify the data flow to a data flow classification;
a policy module configured to:
determine a chosen policy action for the data flow by performing a policy access check for the data flow using the user context information and the data flow classification, and
generate audit information describing the computer activity; and
a profiler module configured to apply a behavior model on the audit information to determine whether computer activity described in the audit information indicates a risk of data leakage from the computer system.

2. The system of claim 1, wherein the behavior model is configured to:
evaluate the audit information, and
generate an alert if the audit information, as evaluated by the behavior model, indicates that the computer activity poses a risk of data leakage from the computer system.

3. The system of claim 2, wherein the profiler module further comprises a threat module configured to determine a threat level based on the alert, wherein the threat level indicates an amount of risk the computer activity poses.

4. The system of claim 3, wherein the threat level is associated with the particular user, the particular computer program, or the computer system.

5. The system of claim 1, wherein when the profiler module determines that the computer activity poses a risk of data leakage from the computer system, a future policy action determination by the policy module is adjusted to account for the risk.

6. The system of claim 1, further comprising an audit trail database configured to receive and store audit information.

7. The system of claim 1, wherein the data flow through the channel is inbound to or outbound from the computer system.

8. The system of claim 1, wherein the channel is a printer, a network storage device, a portable storage device, or a peripheral accessible by the computer system.

9. The system of claim 1, wherein the channel is an electronic messaging application, network protocol or a web page.

10. The system of claim 1, wherein the policy module is further configured to determine the chosen policy action in accordance with a policy that defines a policy action according the to user context information and the data flow classification.

11. The system of claim 1, further comprising a decoder module configured to decode a data block in the data flow before the data flow is classified by the classification module.

12. The system of claim 1, further comprising an interception module configured to intercept a data block in the data flow as the data block passes through the channel.

13. The system of claim 1, further comprising a detection module configured to detect when a data block in the data flow is passing through the channel.

14. The system of claim 1, further comprising a policy enforcement module configured to permit or deny data flow through the channel based on the chosen policy action.

15. The system of claim 1, further comprising a policy enforcement module configured to notify the particular user or an administrator of a policy issue based on the chosen policy action.

16. The system of claim 1, further comprising an agent module configured to gather user context information from the computer system.

17. A method, comprising:
gathering user context information from a computer system interacting with a data flow, wherein the data flow passes through a channel that carries the data flow into or out from the computer system, and wherein the user context information describes computer activity performed on the computer system and associated with a particular user, a particular computer program, or the computer system;
classifying the data flow to a data flow classification;
determining a chosen policy action for the data flow by performing a policy access check for the data flow using the user context information and the data flow classification;
generating audit information describing the computer activity; and
applying a behavior model on the audit information to determine whether computer activity described in the audit information indicates a risk of data leakage from the computer system.

18. The method of claim 17, wherein the behavior model is configured to:
evaluate the audit information, and
generate an alert if the audit information, as evaluated by the behavior model, indicates that the computer activity poses a risk of data leakage from the computer system.

19. The method of claim 18, further comprising determining a threat level based on the alert generated by the behavior model, wherein the threat level indicates an amount of risk the computer activity poses.

20. The method of claim 19, wherein the threat level is associated with the particular user, the particular computer program, or the computer system.

21. The method of claim 17, further comprising adjusting a future policy action determination when the computer activity associated with the particular user, the particular computer program, or the computer system is determined to poses a risk of data leakage from the computer system.

22. The method of claim 17, wherein the data flow through the channel is inbound to or outbound from the computer system.

23. The method of claim 17, wherein the channel is a printer, a network storage device, a portable storage device, or a peripheral accessible by the computer system.

24. The method of claim 17, wherein the channel is an electronic messaging application, network protocol or a web page.

25. The method of claim 17, wherein the chosen policy action is determined in accordance with a policy that defines a policy action according to the user context information and the data flow classification.

26. The method of claim 17, further comprising decoding a data block in the data flow before the data flow is classified.

27. The method of claim 17, further comprising detecting a data block in the data flow as the data block passes through the channel.

28. The method of claim 17, further comprising intercepting the data block in the data flow as the data block passes through the channel.

29. The method of claim 20, further comprising permitting or denying passage of the data block through the channel based on the chosen policy action.

30. The method of claim 17, further comprising generating a notification to the particular user or an administrator based on the chosen policy action.

31. The method of claim 17, further comprising collecting the user context information from the computer system.

32. A computer readable medium configured to store executable instructions, the instructions being executable by a processor to perform a method, the method comprising:
gathering user context information from a computer system interacting with a data flow, wherein the data flow passes through a channel that carries the data flow into or out from the computer system, and wherein the user context information describes computer activity performed on the computer system and associated with a particular user, a particular computer program, or the computer system;
classifying the data flow to a data flow classification;
determining a chosen policy action for the data flow by performing a policy access check for the data flow using the user context information and the data flow classification;
generating audit information describing the computer activity; and
applying a behavior model on the audit information to determine whether computer activity described in the audit information indicates a risk of data leakage from the computer system.

33. A system comprising:
a means for gathering user context information from a computer system interacting with a data flow, wherein the data flow passes through a channel that carries the data flow into or out from the computer system, and wherein the user context information describes computer activity performed on the computer system and associated with a particular user, a particular computer program, or the computer system;
a means for classifying the data flow to a data flow classification;
a means for determining a chosen policy action for the data flow by performing a policy access check for the data flow using the user context information and the data flow classification;
a means for generating audit information describing the computer activity;
a means for applying a behavior model on the audit information to determine whether computer activity described in the audit information indicates a risk of data leakage from the computer system.
